(19) United States
(12) Patent Application Publication
(10) Pub. No.: US 2009/0261251 A1
(43) Pub. Date: Oct. 22, 2009

(54) INSPECTION APPARATUS AND INSPECTION METHOD

(75) Inventors: Koichi HAYAKAWA, Hitachinaka (JP); Masaaki NOJIRI, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/423,301

(22) Filed: Apr. 14, 2009

(30) Foreign Application Priority Data
Apr. 17, 2008 (JP) 2008-107384

(51) Int. Cl. G01N 23/00; H01J 3/14

(52) U.S. Cl. 250/310; 250/396 R

(57) ABSTRACT

Inspection apparatus and method adapted to inspect a sample by irradiating it with an electron beam and detecting defects on the sample from an image formed based on a secondary signal generated from the sample. The inspection apparatus includes: a scanning deflector for scanning the sample with a beam having an irradiation energy for imaging irradiation regions of the sample, a blanking deflector for blanking the beam to prevent it from irradiating the sample during scanning, a moving stage for continuously moving the sample during scanning such that the beam is deflected and scanned continuously from one side of the sample to the other, and a controller for sending a deflection command to the blanking deflector to blank the beam over nonirradiation regions of the scanning regions of the sample according to selection of irradiation regions of the sample.

### FIELD OF THE INVENTION

The present invention relates to techniques for inspecting fine circuit patterns formed on a semiconductor wafer for foreign matter during a process for manufacturing semiconductor devices having the circuit patterns formed thereon.

### BACKGROUND OF THE INVENTION

A process for manufacturing semiconductor devices includes a step for transferring a pattern formed on a photomask to a semiconductor wafer by lithography and etching. In order to achieve a higher yield in manufacturing semiconductor devices, it is necessary to inspect whether a circuit pattern complying with design specifications is formed on a semiconductor wafer by lithography and etching. Simultaneously, it is necessary to inspect for generation of faults (such as pattern crack and shorting) and adhesion of foreign matter during the manufacturing process. Various tools for inspecting patterns on a semiconductor wafer during its manufacturing process are used to detect the generation of faults or abnormalities at an earlier stage or in advance during the fabrication process.

A method of inspecting a pattern on a semiconductor wafer for defects is implemented by a defect inspection system that has been put into practical use. The inspection system irradiates the semiconductor wafer with a charged particle beam such as an electron beam, detects secondary electrons or backscattered electrons emanating from the wafer, and images the resulting signal, thus detecting defects. For the detection of the defects, a pattern of inspection regions is compared with a reference pattern that should be identical with the pattern of the inspection regions. Pixels having differences are detected as defects. Accordingly, geometry differences due to defective manufacturing of the circuit pattern and foreign matter can be detected. In the case of memory mats, the same pattern is repeated. Successive patterns are compared repetitively. If any difference is extracted, it can be detected as a defect.

Because the spot of an electron beam is very small, an inspection apparatus using the electron beam is low in throughput, i.e., the number of semiconductor wafers that can be inspected per hour. Accordingly, a technique of producing an image by one or a few high-speed scans using a large-current electron beam is known. Yet, the process is time-consuming. Therefore, attempts have been made to prevent deterioration of the throughput by inspecting only regions of interest rather than the whole semiconductor wafer surface as described, for example, in JP-A-2007-003404A1 by making the best use of inspection employing an electron beam.

Floating pad regions are present around a cell mat region of a semiconductor device. Inspection is performed by adjusting the irradiation energy imparted by the electron beam irradiation to a value adapted for inspection of the cell mat region. Because the irradiation energy of the beam is constant over the whole semiconductor wafer, the beam hits the floating pad regions as well as the cell mat region. If the floating pad regions are irradiated with the electron beam, the regions are charged with electrons. This greatly varies the electric potentials around the floating pad regions. When an image is acquired by irradiating a cell mat region with an electron beam, the charging bends the orbit of the beam. As a result, the image will be out of focus or distortion will be generated in the image. This presents the problem that it is impossible to make a comparison inspection. Furthermore, if the semiconductor wafer is electrically charged greatly, electrostatic breakdown damages the wafer. In addition, portions of the cell mat region which are adjacent to the floating pad regions are affected by the charging of the floating pad regions. Consequently, the image becomes whitish, resulting in non-uniform brightness. When an image of the cell mat region undergoes a comparison inspection, the brightness non-uniformity will be detected as a defect.

### SUMMARY OF THE INVENTION

It is an object of the present invention to provide inspection apparatus and method which, during inspection of a pattern on a semiconductor wafer, can inspect desired regions while preventing an electron beam from irradiating noninspection regions if such noninspection regions are present as well as the inspection regions on the sample.

An embodiment of the present invention which achieves the foregoing object provides an inspection apparatus used to inspect a semiconductor device having a circuit pattern. The inspection apparatus irradiates a sample with an electron beam, forms an image based on a secondary signal emanating from the sample, and detects defects on the sample from the image if such detects are present. The electron beam has an irradiation energy for imaging regions of the sample irradiated with the beam. The inspection apparatus has a scanning deflector for scanning the beam over the sample, a blanking deflector for blanking the beam during the scanning of the beam to prevent the beam from irradiating the sample, a moving stage for continuously moving the sample during the scanning of the beam such that the beam is deflected and scanned continuously from one side of the sample to the other, and a controller for sending a deflection instruction to the blanking deflector to blank the beam over nonirradiation regions of an area of the sample scanned with the beam according to selection of irradiation regions of the scanning area of the sample.

According to the present invention, inspection apparatus and method can be offered which, when a pattern on a semiconductor wafer is inspected, can inspect desired regions while preventing the electron beam from irradiating noninspection regions if the noninspection regions are present as well as the inspection regions on the sample.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic block diagram of an inspection apparatus using an electron beam;

FIG. 2 shows a menu screen displayed on the display portion of an interface;

FIG. 3 is conceptual view illustrating control of scanning of an electron beam over a substrate to be inspected;

FIG. 4 is a conceptual view illustrating control of scanning of the electron beam over the substrate to be inspected;

FIG. 5 is conceptual view illustrating control of scanning of the electron beam over the substrate to be inspected;

FIG. 6 is a plan view of the substrate to be inspected;

FIG. 7 shows an image displayed on the display portion of the interface;

FIG. 8 shows another image displayed on the display portion of the interface; and

FIG. 9 is a time chart illustrating control of the electron beam.

### DETAILED DESCRIPTION OF THE EMBODIMENTS

Embodiments of the present invention are hereinafter described with reference to the drawings.

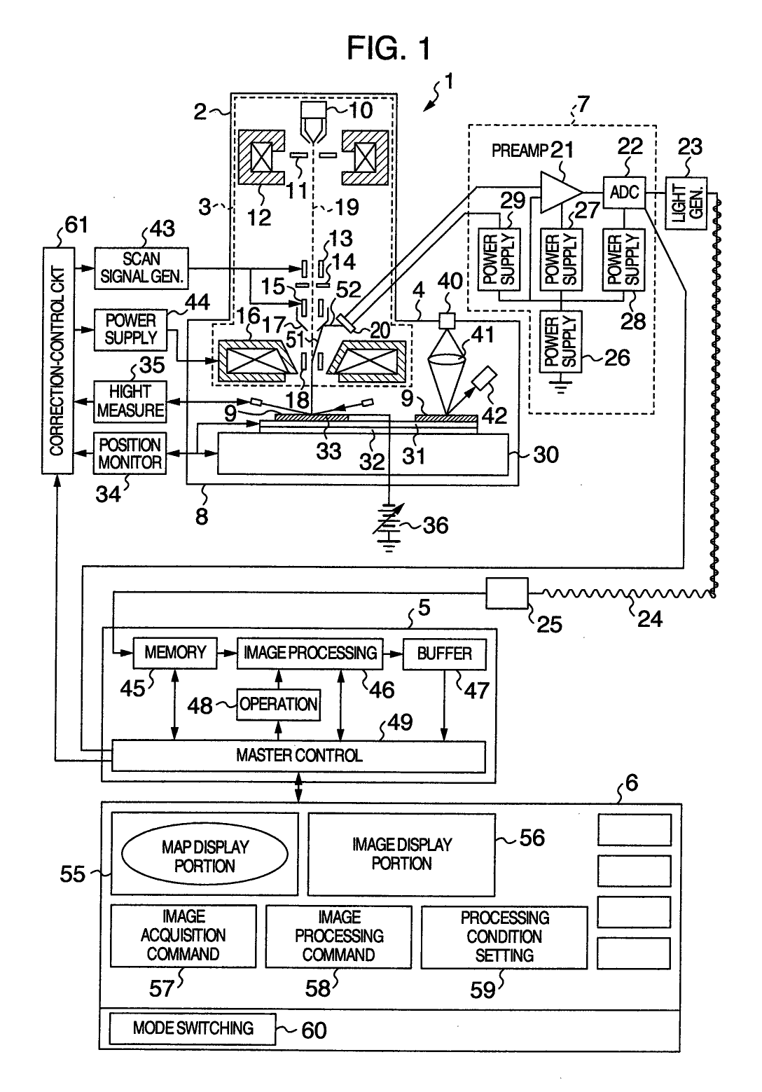

FIG. 1 is a block diagram of an inspection apparatus using an electron beam. Its main configuration is shown in substantially vertical cross section and functional diagram. The inspection apparatus, generally indicated by reference numeral 1, has an inspection chamber 2 whose interior is evacuated to a vacuum and a preliminary chamber (not shown) for conveying a substrate to be inspected 9 into the inspection chamber 2. The preliminary chamber is designed to be capable of being evacuated to a vacuum independently of the inspection chamber 2. Furthermore, the inspection apparatus 1 has an image processing portion 5, in addition to the inspection chamber 2 and preliminary chamber.

The inspection chamber 2 is, broadly speaking, composed of an electron optical column 3, a sample chamber 8, and an optical microscope chamber 4. The electron optical column 3 is made up of an electron gun 10, an extraction electrode 11, a system of condenser lenses 12, a blanking deflector 13, an aperture 14, a scanning deflector 15, an objective lens 16, a reflective plate 17, an E×B deflector 18, and a secondary electron detector 20. The column 3 directs an electron beam 19 at the substrate to be inspected 9 and detects secondary electrons generated from the substrate 9.

The sample chamber 8 is composed of a sample support 30, an X stage 31, a Y stage 32, a rotary stage 33, a position monitoring metrology tool 34, and a substrate height measuring instrument 35.

The optical microscope chamber 4 is disposed inside the inspection chamber 2 and close to the electron optical column 3. The optical microscope chamber 4 is spaced from the electron optical column 3 such that the chamber 4 and column 3 do not affect each other. The optical microscope chamber 4 is made up of a light source 40, an optical lens 41, and a CCD camera 42. The distance between the electron optical column 3 and the optical microscope chamber 4 is already known. The X stage 31 or Y stage 32 reciprocates between the electron optical column 3 and the optical microscope column 4 for a known distance.

An electron signal detection portion 7 has a preamplifier 21 for amplifying the output signal from the secondary electron detector 20 and an analog-to-digital converter (ADC) 22 for converting the amplified analog signal into digital form. The detection portion 7 further includes a preamplifier power supply 27, an ADC power supply 28, a reverse-bias power supply 29, and a high-voltage power supply 26 for supplying electric power to the power supplies 27-29. The preamplifier power supply 27 and the ADC power supply 28 operate to drive the preamplifier 21 and ADC 22, respectively. The amplified digital signal is converted into a light signal by a light generator (i.e., electricity to light conversion means) 23 and passed through a light transmission means 24. Then, the light signal is converted into an electric signal by a photoelectric means 25 and sent to a storage means 45 in the image processing portion 5. An optical image acquired by the CCD camera 42 is similarly sent to the image processing portion 5 in a manner not illustrated.

The image processing portion 5 includes the storage means 45, an image processing circuit 46, a defect data buffer 47, a calculation portion 48, and a master control portion 49. Signals stored in the storage means 45 are imaged by the image processing circuit 46. Furthermore, the image processing circuit performs various kinds of processing including positional alignment of images located in positions spaced apart by a given distance, normalization of signal levels, and removal of noise signals. Image signals are computationally compared. The calculation portion 48 compares the absolute values of differential image signals obtained by the computational comparison with a given threshold value. If the levels of the differential image signals are greater than the given threshold value, objects represented by the images are judged to be candidate defects. The calculation portion 48 sends information about the candidate defects such as the positions and the number of them to an interface 6. The master control portion 49 controls these image processing and computations, and sends a signal indicating the status to a correction control circuit 61.

An electron beam image or optical image is displayed on the image display portion 56 of the interface 6. Regarding operation instructions and operation conditions for various portions of the inspection apparatus 1, instructions are entered from the interface 6 and then sent from the master control portion 49 of the image processing portion 5 to the correction control circuit 61. On the interface 6, various conditions including the acceleration voltage used when the electron beam 19 is produced, deflection width, deflection speed, the timing at which the signal from the electron signal detection portion 7 is accepted, and moving speeds of the X stage 31 and Y stage 32 can be selected and set optionally according to the purpose.

The interface 6 has the function of a display unit, for example. On a map display portion 55, detected defects are symbolized and their distribution is displayed in a map that pictorially represents a semiconductor wafer being the substrate to be inspected 9. An image acquisition instruction region 57 is a portion for issuing an instruction to obtain an electron beam image or optical image from each detected defect or each region. An image processing region 58 is a portion for giving instructions for adjusting the brightness or contrast of the acquired image. A processing condition setting region 59 is used to set various conditions including deflection width with which the electron beam 19 is directed at the substrate to be inspected 9, deflection velocity, focal distance of the objective lens, and depth of focus.

A mode switching button 60 is disposed on the screen of the display to permit the user to select a mode from “inspection”, “check of defect”, “recipe creation”, and “utilities”. In the “recipe creation” mode, conditions under which an automated inspection is performed are set. The “utilities” mode does not appear in any other mode.

The correction control circuit 61 controls such that the various conditions, including the acceleration voltage used when the electron beam 19 is produced, deflection width, deflection speed, the timing at which the signal from the electron signal detection portion 7 is accepted, and moving speeds of the X stage 31 and Y stage 32, comply with the instructions sent in from the master control portion 49 of the image processing portion 5. Furthermore, the control circuit 61 monitors the position and height of the substrate to be inspected 9 from the signals from the position-monitoring metrology tool 34 and substrate-height measuring instrument 35, creates a correction signal from the results, sends the correction signal to a scanning-signal generator 43 and to an objective-lens power supply 44, and varies the deflection width, deflection speed, focal distance of the objective lens, and depth of focus such that the electron beam 19 impinges at the correct position at all times.

A diffusion supply type thermal field emission electron source is used as the electron gun 10. Use of the electron gun 10 makes it possible to secure a stabler electron beam current than when conventional electron sources (e.g., tungsten filament electron source and cold field emission electron source) are used. Consequently, a final image suffering from less brightness variations can be obtained. Furthermore, high-speed inspection can be accomplished because the electron gun 10 permits the electron beam current to be set to large values.

The electron beam 19 is extracted from the electron gun 10 by applying a voltage between the electron gun 10 and extraction electrode 11. Acceleration of the beam 19 is determined by applying a negative high-voltage potential to the gun 10. In consequence, the beam 19 travels toward the sample support 30 at an energy corresponding to the potential, and is converged by the system of condenser lenses 12. Then, the beam is sharply focused by the objective lens 16 onto the substrate to be inspected 9 placed on the sample support 30.

The blanking deflector 13 and scanning deflector 15 are controlled by the scanning signal generator 43 producing a blanking signal and a scanning signal. The blanking deflector 13 is a mechanism for deflecting the electron beam 19 to prevent the beam 19 from passing through the opening in the aperture 14, thus preventing the beam 19 from irradiating the substrate to be inspected 9. The beam 19 is sharply focused by the objective lens 16 and scanned over the substrate 9 by the scanning deflector 15. Either reciprocative scanning or one-way scanning can be selected as the scanning. In the reciprocative scanning, the sharply focused electron beam 19 is made to irradiate the sample in the going and returning paths. In the one-way scanning, the beam in the going path hits the sample but the beam 19 is blanked out by the blanking deflector 13 in the returning path to prevent the beam 19 from irradiating the sample although the scanning signal for the beam 19 is applied to the scanning deflector 15.

In an automated inspection apparatus, it is desired that the inspection speed be made as high as possible, unlike ordinary scanning electron microscopy (SEM) where an electron beam having an electric current on the order of pA is scanned at low speed. Furthermore, multiple scans should not be made. In addition, images should not be superimposed. Further, charging of insulator materials should be suppressed. Accordingly, it is necessary to scan the electron beam once or a few times at high speed. For example, an image can be created by scanning a sample only once with a large-current electron beam, for example, of 100 nA, which is about 100 times or more as large as the current used in ordinary SEM. The circuit pattern inspection apparatus of the present embodiment is so set up that the electron beam can be scanned only once and a few times.

The strength of the objective lens 16 can be varied by adjusting the voltage produced from the objective-lens power supply 44 by the correction-control circuit 61. Furthermore, the strength of the system of condenser lenses 12 can be varied by adjusting the voltage produced from a lens power supply (not shown) by the correction control circuit 61.

A negative voltage can be applied to the substrate to be inspected 9 from a retarding power supply 36. The electron beam is decelerated by adjusting the voltage from the retarding power supply 36. Thus, the energy of the beam imparted to the irradiated substrate 9 can be adjusted without varying the potential on the electron gun 10.

The substrate to be inspected 9 is mounted on the X stage 31 and Y stage 32. During execution of an inspection, two methods are available. In one method, the X stage 31 and Y stage 32 are kept at rest while the beam 19 is scanned in two dimensions. In the other method, the X stage 31 is kept at rest while the Y stage 32 is continuously moved at a constant speed in the Y-direction. Under these conditions, the beam 19 is scanned in the X-direction. Where a relatively narrow certain region is inspected, the former method where the translation stages are kept at rest is used advantageously. Where a relatively broad region is inspected, the latter method where one translation stage is continuously moved at a constant speed is used advantageously.

Where an image of the substrate to be inspected 9 is acquired while continuously moving one of the X stage 31 and Y stage 32, the electron beam 19 is scanned in a direction substantially perpendicular to the direction of motion of the stage. Secondary electrons produced from the substrate 9 are detected by the secondary electron detector 20 in synchronization with the scanning of the beam 19 and movement of the stage.

Secondary electrons produced by irradiating the substrate to be inspected 9 with the electron beam 19 are accelerated by a negative voltage applied to the substrate 9. The E×B deflector 18 is positioned above the substrate 9 to deflect the accelerated secondary electrons in a desired direction. The amount of deflection can be adjusted by varying the strength of the magnetic field, which in turn is achieved by varying the voltage applied to the deflector 18. The electromagnetic field produced by the E×B deflector 18 can be varied in synchronization with the negative voltage applied to the substrate 9. The secondary electrons deflected by the deflector 18 collide against the reflective plate 17 under certain conditions. The reflective plate 17 that is conic in shape acts also as a shield pipe for the scanning deflector 15 for the electron beam 19 impinging on the substrate 9. When the accelerated secondary electrons collide against the reflective plate 17, second secondary electrons having energies of a few eV to 50 eV are produced from the reflective plate 17.

In the present embodiment, a metrology instrument employing the principle of laser interference is used as the position monitoring metrology tool 34 in the X- and Y-directions. The positions of the X stage 31 and Y stage 32 are measured while the sample is being irradiated with the electron beam 19. The resulting signal is sent to the correction control circuit 61. The X stage 31, Y stage 32, and rotary stage 33 are driven by their respective drive motors. Drive circuits (not shown) for driving the drive motors send signals indicating the rotational speeds of the motors to the correction control circuit 61. The control circuit 61 can precisely grasp the region irradiated with the beam 19 and its position based on the data carried by the signals, and corrects the deviation of the position of the beam 19 on the sample. Furthermore, the region irradiated with the beam 19 can be stored in memory.

An optical measuring instrument that is an apparatus not using an electron beam such as a metrology instrument employing laser interferometry or a reflected light type metrology instrument for measuring variations in the position of reflected light is used as the substrate height measuring instrument 35. For example, in a known system, white light passed through a slit and having an elongated contour is directed at the substrate to be inspected 9 through a transparent window, the position of the reflected light is detected, and the amount of variation in height is calculated from the variation in position. The substrate height measuring instrument 35 is mounted over the X stage 31 and Y stage 32 and measures the height of the substrate to be inspected 9. The focal distance of the objective lens 16 for sharply focusing the electron beam 19 is dynamically corrected based on data obtained by the measurement performed using the height measuring instrument 35 to permit the focused beam 19 to irradiate a noninspection region at all times. It is also possible that warpage and height distortion of the substrate to be inspected 9 are measured before the sample is irradiated with the beam 19 and that correction conditions for the objective lens 16 are set for each inspected region based on the obtained data.

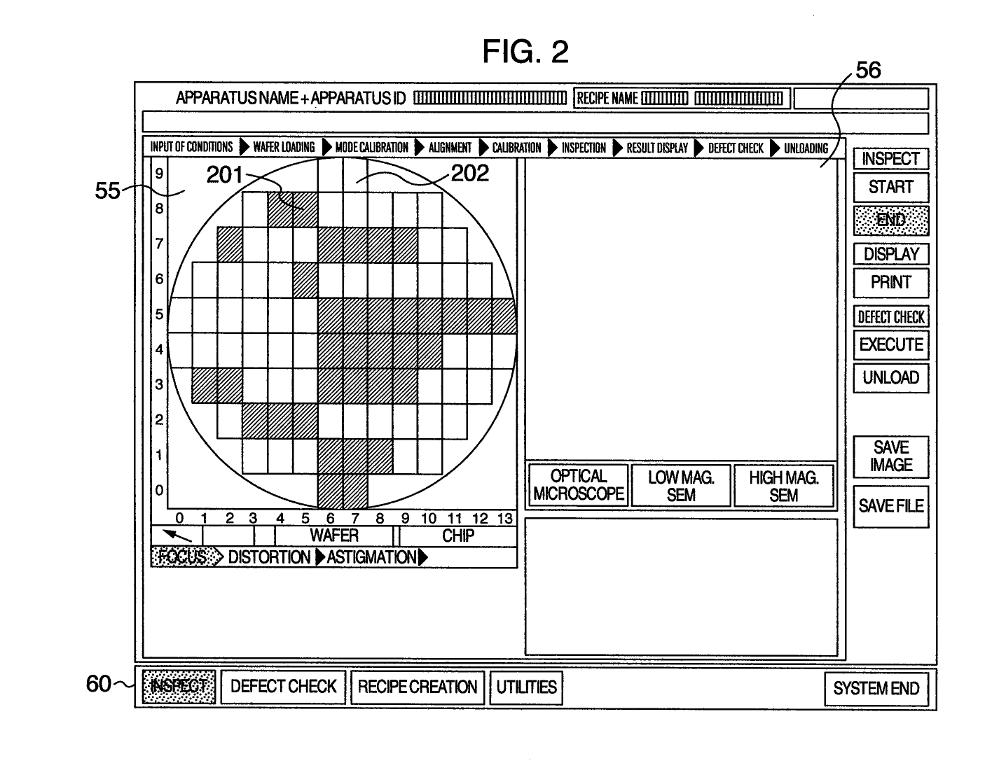

FIG. 2 shows one example of a menu screen displayed on the display portion of the interface 6. A map display portion 55 and image display portion 56 occupy large areas in the menu screen. It is also possible to prepare two display units on which the map display portion 55 and image display portion 56 may be displayed respectively instead of being displayed within one display screen. The mode selecting buttons 60 are arranged under the display portions 55 and 56 to permit the user to select various modes “inspection”, “defect check”, “recipe creation”, and “utilities”. In the “recipe creation” mode, operation conditions under which an automated inspection is performed are set. In the “utilities” mode, an auxiliary function not appearing in any other mode is called. Usually, the “utilities” mode is not used.

The layout of the dies on the inspected semiconductor wafer is schematically shown in the map display portion 55 of FIG. 2. Some of the dies are specified as dies 201 subjected to inspection. The other dies are specified as dies 202 not subjected to inspection. They are classified by color and displayed. Information about the dies specified to be inspected on this menu screen is sent to the master control portion 49 shown in FIG. 1.

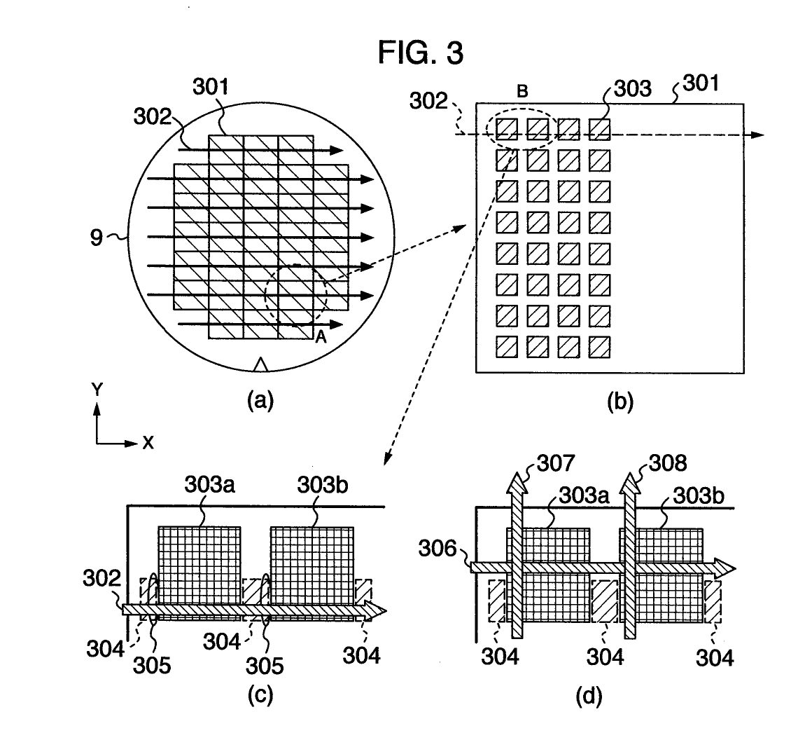

FIG. 3 is conceptual view illustrating control of the scanning of the electron beam 19 over the substrate to be inspected 9. (a) is a plan view of the substrate 9. (b) is an enlarged view of portion A of (a). (c) and (d) are enlarged views of portion B of (b).

In (a), dies 301 are arranged vertically and horizontally on the substrate to be inspected 9. If the X stage 31 is moved in the negative X-direction while scanning the electron beam 19 in the Y-direction over the dies 301, the substrate 9 is relatively scanned from end to end with a striped inspection region 302 having a scanning width. As shown in (b), on each die 301, a plurality of cell mat regions 303 of the same pattern such as memory cells are juxtaposed. An image is obtained by scanning the cell mat regions 303 with the striped inspection region 302 by the electron beam as shown in (c). A defect, if any, can be detected by comparing cell mat regions 303a and 303b.

The electron beam has an irradiation energy for imaging cell mat regions. In the case where a floating pad 304 is present between adjacent cell mat regions, if the pad 304 is irradiated with an electron beam, the pad will be electrically charged, producing a possibility of electrostatic breakdown as indicated by 305. Accordingly, it is conceivable to adopt a method consisting of irradiating the substrate with the electron beam so as to avoid the floating pad 304.

In (d), a striped inspection region 306 extending in the X-direction is so set that only the region excluding the floating pad 304 is irradiated with an electron beam. In this case, there is a disadvantage that the region excluding the floating pad 304 cannot be inspected. Furthermore, if striped inspection regions 307 and 308 extending in the Y-direction are formed so as to be irradiated with an electron beam, every region can be inspected. However, it is necessary to move the translation stage in the Y-direction continuously. Therefore, before the inspection, it is necessary to set the direction and order of striped inspection regions such that the floating pad 304 is avoided. This increases the required steps. If both X-direction inspection and Y-direction inspection are mixed, there is a possibility that the throughput is deteriorated accordingly.

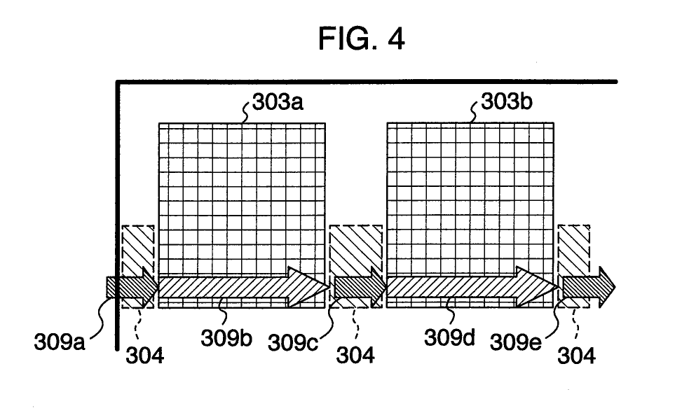

FIG. 4 is a conceptual view illustrating the control of scanning of the electron beam 19 over the substrate to be inspected 9. FIG. 4 is an enlarged view of portion B of FIG. 3 (b) in the same way as FIGS. 3 (c) and (d). In the embodiment of FIG. 4, the beam is scanned in the X-direction in the same way as the striped inspection region 302 of FIG. 3 (c). In the region of the floating pad 304, the beam 19 is deflected by the blanking deflector 13 shown in FIG. 1 and blocked by the aperture 14 as shown in striped inspection regions 309a, 309c, and 309e such that the beam 19 does not irradiate the region of the floating pad 304. As shown in the striped inspection regions 309b and 309d, the inspected cell mat regions 303a and 303b are irradiated with the electron beam without blanking it. Cell mat regions and the region of the floating pad are displayed on the inspection-region-setting menu screen as shown in FIG. 2 based on information about the inspected semiconductor wafer. The interface 6 is made to calculate the timing of blanking by specifying cell mat regions as inspection regions. A signal indicating the calculated timing is sent to the master control portion 49 of the image processing portion 5. During inspection, the master control portion 49 sends a signal indicating the timing of blanking to the correction control portion 61. The scanning signal generator 43 controls the blanking deflector 13 that is deflecting the electron beam 19.

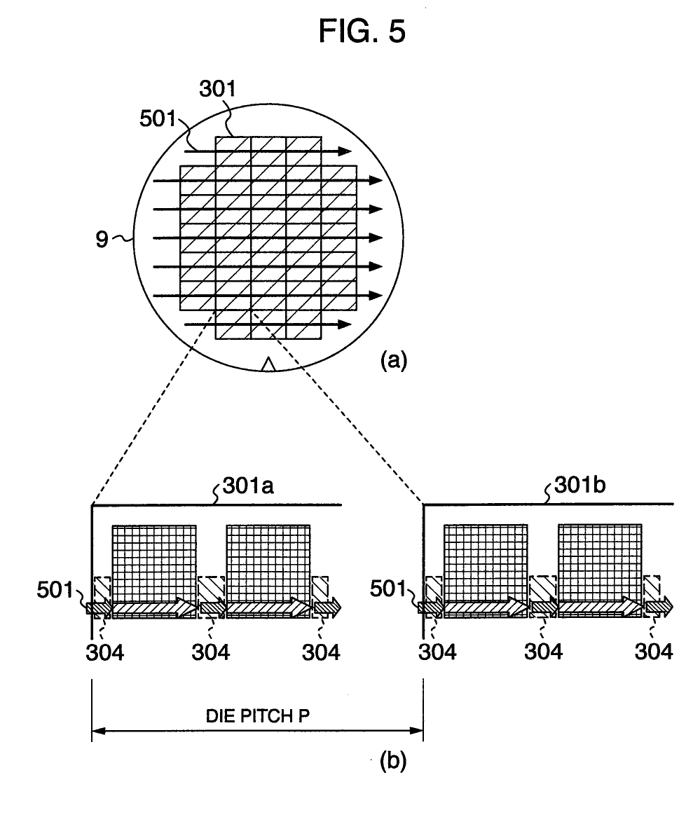

FIG. 5 is conceptual view illustrating control of scanning of the electron beam 19 over the substrate to be inspected 9. (a) is a plan view of the substrate 9. (b) is an enlarged view of the portion B of FIG. 3. Because dies 301a and 301b are formed to have the same shape and same dimensions, the timing at which the beam is blanked over the striped inspection regions 309a, 309c, 309e and the striped inspection regions 309b, 309d shown in FIG. 4 are the same even if the dies are different. Accordingly, as shown in (b), an inspection can be performed using the same blanking data for every die pitch P such that the floating pad 304 in the striped inspection region 501 is not irradiated with the electron beam. Hence, only desired regions on dies can be inspected by applying the function of blanking in this way.

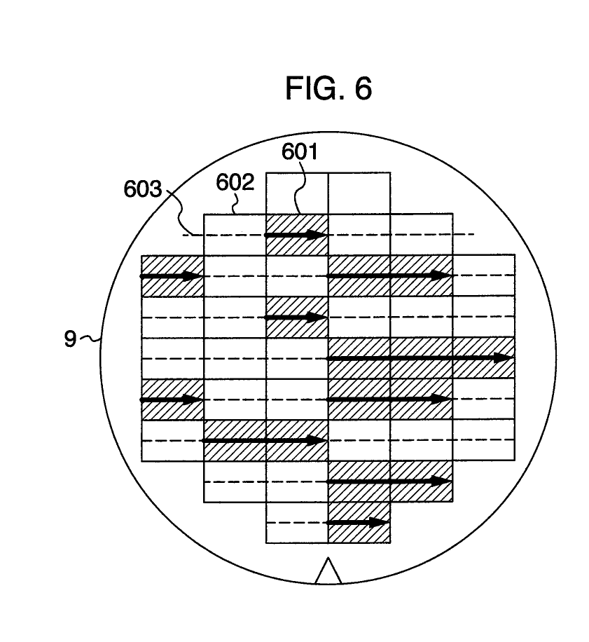

FIG. 6 is a plan view of the substrate to be inspected 9, illustrating control of striped inspection regions 603 in a case where hatched dies 601 are inspected but unhatched dies 602 are not. As already described in connection with FIG. 2, information about the inspected dies is sent to the master control portion 49 shown in FIG. 1 by specifying the dies 201 to be inspected from the layout of inspected semiconductor wafer dies displayed in the map display portion 55. As already described in connection with FIG. 4, with respect to the inspected dies 201, cell mat regions are distinguished from the region of the floating pad. The electron beam is so controlled that only the cell mat regions are irradiated with the beam. At this time, the uninspected dies 602 do not need to be irradiated with the beam. Therefore, the master control portion 49 controls the beam to blank it over the regions of the uninspected dies 602, in the same way as in the control of the beam over the cell mat regions and the region of the floating pad as already described in connection with FIG. 4.

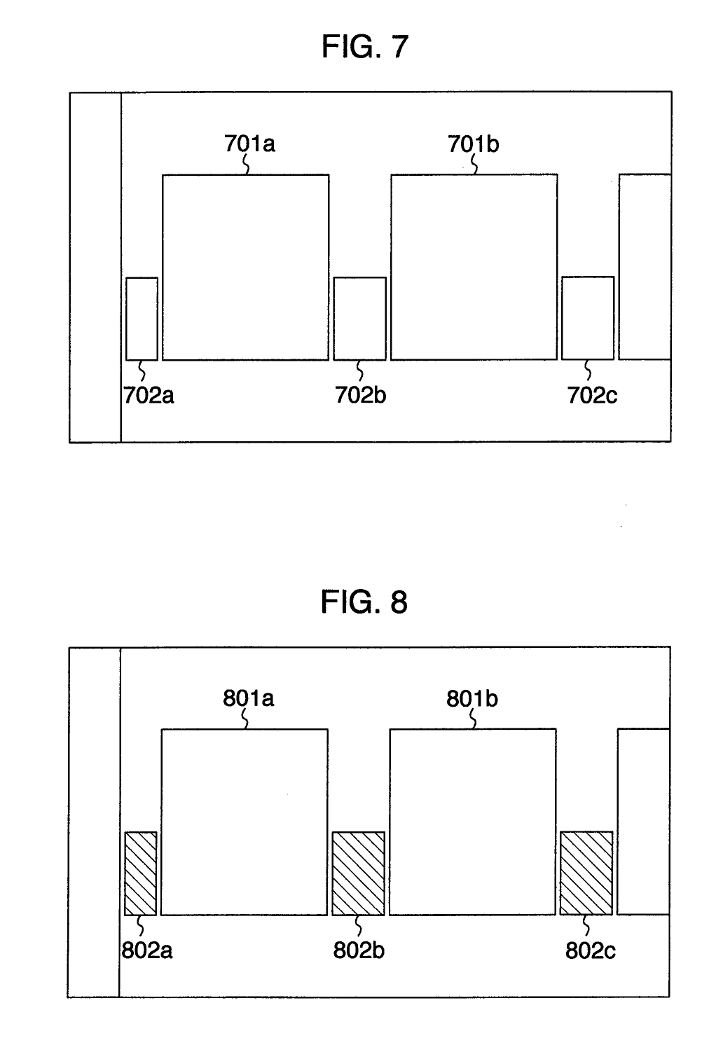

FIG. 7 shows one example of an image displayed on the display portion of the interface 6. Instead of the map display portion 55 shown in FIG. 2, cell mat regions 701a, 701b and floating mat pad regions 702a, 702b, 702c are schematically shown based on design information about the die circuit pattern as shown in FIG. 4. If the cell mat region 701a is specified as an inspected region using the menu screen on the display, and if the process is set to be repeated using a button (not shown), a plurality of cell mat regions including the cell mat region 701b are set as inspected regions. It is possible to prevent the floating pad region from being irradiated with the beam during inspection. This prevention can also be achieved using a method consisting of setting the floating pad regions 702a, 702b, and 702c as noninspection regions and setting the other regions as inspected regions. In some cases, the floating pad region 702a at an end of the die is different in shape from the floating pad regions 702b and 270c as shown in FIG. 7. In this case, the left side to the floating pad region 702a is also an noninspection region. Accordingly, both are specified as noninspection regions. Then, a plurality of floating pad regions including the floating pad regions 702b and 702c are set as noninspection regions by specifying the floating pad region 702b and setting the process to be repeated using the button (not shown).

FIG. 8 shows one example of an image displayed on the display portion of the interface 6. An image obtained by irradiating the cell mat regions and floating mat regions irrespective of the regions with an electron beam having an irradiation energy smaller than the irradiation energy for inspecting the cell mat region is displayed in the image display portion 56 shown in FIG. 2. The floating pad regions 802a, 802b, and 802c are electrically charged even at the smaller irradiation energy. The cell mat regions 801a and 801b are clearly distinguished from the floating pad regions 802a, 802b, and 802c. Therefore, during inspection, the floating pad regions 802a, 802b, and 802c can be prevented from being irradiated with the beam by specifying the plurality of cell mat regions including the cell mat regions 801a and 801b as inspection regions, by employing the image on the display portion.

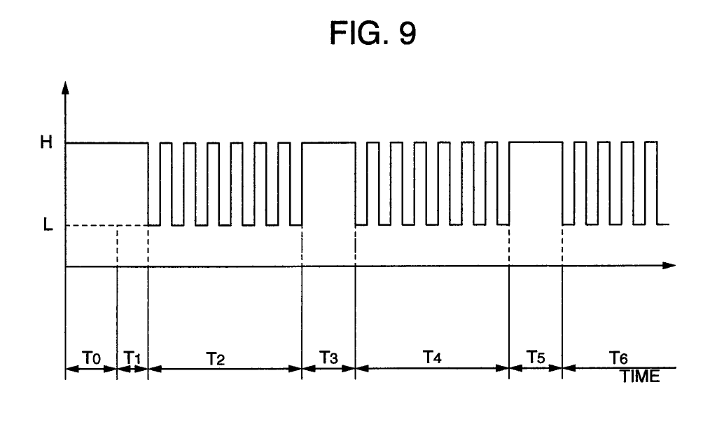

FIG. 9 is a time chart illustrating control of the electron beam. When noninspection or inspection regions shown in FIG. 7 are specified, the master control portion 49 shown in FIG. 1 creates a timing signal for switching the deflection signal from low state (L) to high state (H) to blank the beam for periods of time T₀, T₁, T₃, and T₅ (FIG. 9) corresponding to noninspection regions. The timing signal is sent to the correction control circuit 61. In the control circuit 61, the blanking signal for the noninspection regions is superimposed on the blanking signal used when the beam is continuously scanned. As shown in FIG. 9, a blanking signal used when the electron beam is continuously scanned over the inspection regions during periods of time T₂, T₄, and T₆ and a blanking signal used when the beam is blanked over the noninspection regions during periods of time T₀, T₁, T₃, and T₅ are combined and sent to the scanning signal generator 43. The beam can be blanked over the noninspection regions set in FIG. 7 by the blanking deflector 13.

As described so far, according to the present embodiment, inspection apparatus and method can be offered which prevent noninspection regions from being irradiated with an electron beam during inspection of patterns on semiconductor wafers, if the sample contains the noninspection regions together with inspection regions, whereby the desired inspection regions can be inspected.

It should be further understood by those skilled in the art that although the foregoing description has been made on embodiments of the invention, the invention is not limited thereto and various changes and modifications may be made without departing from the spirit of the invention and the scope of the appended claims.

1. An inspection apparatus for inspecting a semiconductor device having a circuit pattern by irradiating a sample with an electron beam and detecting defects on the sample from an image formed based on a secondary signal generated from said sample, said inspection apparatus comprising:
a scanning deflector for scanning said sample with said electron beam having an irradiation energy for imaging irradiation regions of said sample;
a blanking deflector for blanking said electron beam to prevent said beam from irradiating said sample during the scanning of said beam;
a moving stage for continuously moving said sample during the scanning of said beam such that said beam is deflected and scanned continuously from one side of said sample to the other; and
a controller for sending a deflection command to said blanking deflector to blank said beam over nonirradiation regions of said scanning regions of said sample according to selection of irradiation regions of said sample.

2. An inspection apparatus as set forth in claim 1, further comprising a display unit on which a menu screen permitting a user to select said irradiation regions of said sample is displayed.

3. An inspection apparatus as set forth in claim 2, wherein said irradiation regions of said sample are selected using design information about a circuit pattern on said sample, the design information being displayed on said display unit.

4. An inspection apparatus as set forth in claim 2, wherein said irradiation regions of said sample are selected using an image obtained by irradiating said sample with an electron beam having an irradiation energy lower than the irradiation energy for imaging said irradiation regions of said sample.

5. An inspection apparatus as set forth in claim 1, wherein said irradiation regions are memory cell mat regions on dies of said sample.

6. An inspection apparatus as set forth in claim 1, wherein said nonirradiation regions of said sample are floating pad regions on dies of said sample.

7. An inspection apparatus as set forth in claim 1, wherein said irradiation regions of said sample are die areas for inspection on said sample.

8. An inspection apparatus as set forth in claim 1, wherein formation of said image is ceased when said electron beam is being blanked by said blanking deflector.

9. A method of inspecting a semiconductor device having a circuit pattern by irradiating a sample with an electron beam and detecting defects on the sample from an image formed based on a secondary signal generated from said sample, said method comprising the steps of:
continuously moving said sample during scanning of said electron beam having an irradiation energy for imaging irradiation regions of said sample such that said beam is deflected and scanned continuously from one side of said sample to the other; and
blanking said beam over nonirradiation regions of said scanning regions of said sample according to selection of irradiation regions of said sample to prevent said beam from irradiating the sample.

10. A method of inspecting a semiconductor device as set forth in claim 9, further comprising the step of:
displaying a menu screen permitting a user to select said irradiation regions of said sample on a display unit.

11. A method of inspecting a semiconductor device as set forth in claim 10, wherein said irradiation regions of said sample are selected using design information about a circuit pattern on said sample, the design information being displayed on said display unit.

12. A method of inspecting a semiconductor device as set forth in claim 10, wherein said irradiation regions of said sample are selected using an image obtained by irradiating said sample with an electron beam having an irradiation energy lower than said irradiation energy for imaging said irradiation regions of said sample.

13. A method of inspecting a semiconductor device as set forth in claim 9, wherein said irradiation regions of said sample are memory cell regions on dies of said sample.

14. A method of inspecting a semiconductor device as set forth in claim 9, wherein said nonirradiation regions of said sample are floating pad regions on dies of said sample.

15. A method of inspecting a semiconductor device as set forth in claim 9, wherein said irradiation regions of said sample are die areas for inspection on said sample.

16. A method of inspecting a semiconductor device as set forth in claim 9, wherein formation of said image is ceased when said electron beam is being blanked by said blanking deflector.

17. An inspection apparatus for inspecting a semiconductor device having a circuit pattern by irradiating a sample with an electron beam and detecting defects on the sample from an image formed based on a secondary signal generated from said sample, said inspection apparatus comprising:
a scanning deflector for scanning said electron beam relative to said sample;
a blanking deflector for blanking said electron beam to prevent said beam from irradiating said sample during scanning of said beam;
a moving stage for continuously moving said sample during said scanning of said beam such that said beam is deflected and scanned continuously from one side of said sample to the other; and
a controller for sending a deflection command to said blanking deflector to blank said beam over areas of regions of said sample which are more easily electrically charged than image inspection regions.

18. An inspection apparatus as set forth in claim 17, further comprising a display unit on which a menu screen permitting a user to select said inspection regions or easily electrically charged regions of said sample is displayed.

19. An inspection apparatus as set forth in claim 18, wherein said inspection regions or easily electrically charged regions of said sample are selected using design information about a circuit pattern on said sample, the design information being displayed on said display unit.

20. An inspection apparatus as set forth in claim 18, wherein said inspection regions or easily electrically charged regions of said sample are selected using an image obtained by irradiating said sample with the electron beam having an irradiation energy lower than an irradiation energy for imaging the inspection regions of said sample.

21. An inspection apparatus as set forth in claim 17, wherein said inspection regions of said sample are memory cell mat regions on dies of said sample.

22. An inspection apparatus as set forth in claim 17, wherein said electrically easily charged regions of said sample are floating pad regions on dies of said sample.

23. An inspection apparatus as set forth in claim 17, wherein formation of said image is ceased when said electron beam is being blanked by said blanking deflector.

24. An inspection apparatus for inspecting a semiconductor device having a circuit pattern by irradiating a sample with an electron beam and detecting defects on said sample from an image formed based on a secondary signal generated from said sample, said inspection apparatus comprising:
a scanning deflector for scanning said electron beam relative to said sample;
a blanking deflector for blanking the electron beam to prevent said beam from irradiating said sample during scanning of said beam;
a moving stage for continuously moving said sample during scanning of said beam such that said beam is deflected and scanned continuously from one side of said sample to the other; and
a controller for sending a deflection command to said blanking deflector such that said beam is continuously deflected and scanned over memory cell regions of said sample to create an image and that said beam is blanked over floating pad regions of said sample.

25. An inspection apparatus for inspecting a semiconductor device as set forth in claim 24, further comprising a display unit on which a menu screen permitting a user to select said memory cell regions or said floating pad regions of said sample is displayed.

26. An inspection apparatus for inspecting a semiconductor device as set forth in claim 25, wherein said memory cell regions or said floating pad regions of said sample are selected using design information about a circuit pattern on said sample, the design information being displayed on said display unit.

27. An inspection apparatus for inspecting a semiconductor device as set forth in claim 25, wherein said memory cell regions or said floating pad regions of said sample are selected using an image obtained by irradiating said sample with an electron beam having an irradiation energy lower than said irradiation energy for imaging said memory cell regions.
